(19) United States
(12) Patent Application Publication
(10) Pub. No.: US 2025/0261184 A1
(43) Pub. Date: Aug. 14, 2025

(54) BASE-STATION DEVICE INCLUDED IN BASE-STATION RADIO UNIT, INFORMATION PROCESSING METHOD, AND NON-TRANSITORY RECORDING MEDIUM

(71) Applicant: NEC Corporation, Tokyo (JP)

(72) Inventors: Jeehoon PARK, Tokyo (JP); Kiyohiko TAKAHASHI, Tokyo (JP)

(73) Assignee: NEC Corporation, Tokyo (JP)

(21) Appl. No.: 19/045,696

(22) Filed: Feb. 5, 2025

(30) Foreign Application Priority Data
Feb. 8, 2024 (JP) 2024-017954

(51) Int. Cl. H04W 72/12

(52) U.S. Cl. CPC H04W 72/12

(57) ABSTRACT

A base-station device included in a base-station radio unit, the base-station device is a base-station secondary device, the base-station secondary device including: a first information acquisition part that acquires first information indicating a schedule of signal switching outputted by a base-station primary device included in the base-station radio unit; a second information acquisition part that acquires second information indicating at least one of a rise and a fall of an output signal outputted by the base-station primary device; a counter; and a switching part that performs the signal switching by using the counter, based on the first information and the second information.

### INCORPORATION BY REFERENCE

This application is based upon and claims the benefit of priority from Japanese Patent Application No. 2024-017954, filed on Feb. 8, 2024, the disclosure of which is incorporated herein in its entirety by reference.

### TECHNICAL FIELD

Example embodiments of a present disclosure relate to a schedule management method for communication signals and time synchronization in a base-station radio unit.

### BACKGROUND ART

The fifth-generation mobile communication system uses radio waves in a high-frequency area such as millimeter waves, to achieve high-speed and high-capacity communication. Radio communication with high frequencies is desirably performed in line-of-sight, because the radio waves with higher frequencies increase straightness. For this reason, introduction of a distributed MIMO (Multiple Input Multiple Output) in which base stations are distributed to expand an area allowing line-of-sight communication, is being considered. Since a number of access points need to be installed in the distributed MIMO, it is required to build access points at low cost and low power. This suggests that an apparatus traditionally integrated as a radio unit (RU), may be divided into: a distributed antenna (DA) mainly equipped with an analog front-end to an antenna; and a mixed signal processing unit (MSPU) equipped with a digital signal processor such as a modulator/demodulator, and that communication signals of a plurality of distributed antennas may be processed by a single mixed signal processing unit.

The fifth-generation mobile communication system requires communication schedule control with precise time, since switching between transmission and reception is carried out by time division duplex (TDD). In order to improve utilization efficiency of radio wave resources by performing the time division duplex and suppressing radio wave interference between base stations, as well as removing a guard band at the same time, it is necessary to synchronize transmission and reception switching timing between base stations. For this reason, synchronization is required for Temps Atomique International (TAI) serving as a reference. Furthermore, depending on a communication technique/technology to be introduced, such as carrier aggregation and MIMO, high time synchronization accuracy is required. For example, Japanese Patent No. 6868567 discloses a method of synchronizing switching timing of an uplink and a downlink in the DA using the TDD.

### SUMMARY

It is an example object of the present disclosure to provide a base-station device included in a base-station ratio unit, an information processing method, a computer program, and a recording medium that are capable of solving the above-described technical problems. It is also an example object of the present disclosure to provide a base-station device included in a base-station ratio unit, an information processing method, a computer program, and a non-transitory recording medium that allow time synchronization in a base station.

A base-station device according to an example aspect of the present disclosure is a base-station device included in a base-station radio unit, the base-station device is a base-station secondary device, the base-station secondary device including: a first information acquisition part that acquires first information indicating a schedule of signal switching outputted by a base-station primary device included in the base-station radio unit; a second information acquisition part that acquires second information indicating at least one of a rise and a fall of an output signal outputted by the base-station primary device; a counter; and a switching part that performs the signal switching by using the counter, based on the first information and the second information.

An information processing method according to an example aspect of the present disclosure is an information processing method used by a base-station secondary device included in a base-station radio unit, the information processing method including: acquiring first information indicating a schedule of signal switching outputted by a base-station primary device included in the base-station radio unit; acquiring second information indicating at least one of a rise and a fall of an output signal outputted by the base-station primary device; and performing the signal switching by using a counter included in the base-station secondary device, based on the first information and the second information.

A non-transitory recording medium according to an example aspect of the present disclosure is a non-transitory recording medium on which a computer program that allows a computer to execute an information processing method is recorded, the information processing method including: acquiring first information indicating a schedule of signal switching outputted by a base-station primary device included in a base-station radio unit; acquiring second information indicating at least one of a rise and a fall of an output signal outputted by the base-station primary device; and performing the signal switching by using a counter included in a base-station secondary device in the base-station radio unit, based on the first information and the second information.

### Example Advantage

According to each of the base-station secondary device included in the base-station ratio unit, the information processing method, the computer program, and the non-transitory recording medium in the example aspects of the present disclosure, signal switching is performed by using a counter, based on a schedule of the signal switching outputted by a base-station primary device and based on at least one of a rise and a fall of an output signal outputted by the base-station primary device, and it is thus possible to synchronize a communication schedule of a base station.

### BRIEF DESCRIPTION OF THE DRAWINGS

FIG. 1 is a block diagram illustrating an example of a configuration of a base-station secondary device according to a first example embodiment;

FIG. 2 is a flowchart illustrating an example of a flow of operation of the base-station secondary device according to the first example embodiment;

FIG. 3 is a block diagram illustrating an example of a configuration of a base-station radio unit according to a second example embodiment;

FIG. 4 is a block diagram illustrating an example of a configuration of a distributed antenna according to the second example embodiment;

FIG. 5A to FIG. 5E are charts illustrating an outline of a flow of operation of the distributed antenna according to the second example embodiment;

FIG. 6 is a block diagram illustrating an example of a configuration of a micro controller unit according to a third example embodiment;

FIG. 7A to FIG. 7F are charts illustrating an outline of a flow of operation of a distributed antenna according to the third example embodiment;

FIG. 8A and FIG. 8B are charts illustrating an outline of a flow of operation of a distributed antenna according to a fourth example embodiment;

FIG. 9A to FIG. 9F are charts illustrating an outline of a flow of operation of the distributed antenna according to the fourth example embodiment; and

FIG. 10 is a block diagram illustrating an example of a configuration of a distributed antenna according to a fifth example embodiment.

### EXAMPLE EMBODIMENTS

Hereinafter, a base-station device included in a base-station radio unit, an information processing method, a computer program, and a recording medium according to example embodiments will be described with reference to the drawings.

### 1: First Example Embodiment

A base-station device included in a base-station radio unit, an information processing method, a computer program, and a recording medium according to a first example embodiment will be described. The following describes the base-station device included in the base-station radio unit, the information processing method, the computer program, and the recording medium according to the first example embodiment, by using a base-station secondary device 100 according to the present disclosure.

### 1-1: Configuration of Base-Station Secondary Device 100

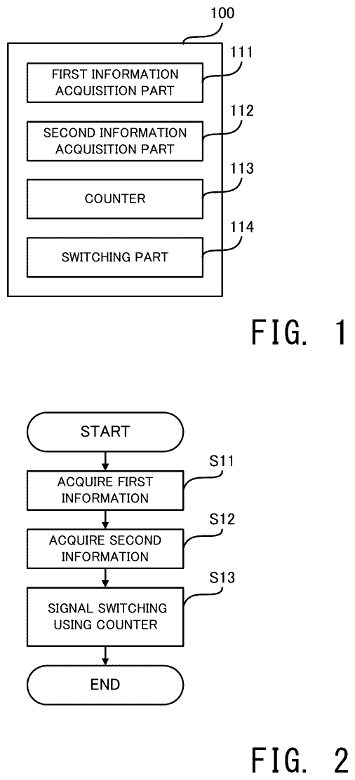

FIG. 1 is a block diagram illustrating a configuration of the base-station secondary device 100 according to the present disclosure. As illustrated in FIG. 1, the base-station secondary device 100 includes a first information acquisition part 111, a second information acquisition part 112, a counter 113, and a switching part 114. The base-station secondary device 100 is included in a base-station radio unit. The base-station radio unit includes a base-station primary device and the base-station secondary device 100, and provides a communication terminal with a radio communication environment.

### 1-2: Information Processing Operation Performed by Base-Station Secondary Device 100

With reference to FIG. 2, an information processing operation performed by the base-station secondary device 100 will be described. As illustrated in FIG. 2, the first information acquisition part 111 acquires first information indicating a schedule of signal switching outputted by the base-station primary device (step S11). The second information acquisition part 112 acquires second information indicating at least one of a rise and a fall of an output signal outputted by the base-station primary device (step S12). The switching part 114 performs the signal switching by using the counter 113, based on the first information and the second information (step S13).

### 2: Second Example Embodiment

A base-station device included in a base-station radio unit, an information processing method, a computer program, and a recording medium according to a second example embodiment will be described. The following describes the base-station device included in the base-station radio unit, the information processing method, the computer program, and the recording medium according to the second example embodiment, by using a distributed antenna DA serving as the base-station secondary device according to the present disclosure. In the second and subsequent example embodiments, a case where a distributed MIMO base-station radio unit provides a communication terminal with a radio communication environment by a distributed MIMO, will be described as an example. The present disclosure, however, is also applicable to a base station in which a base-station primary device and a base-station secondary device are separate, in addition to the distributed MIMO.

### 2-1: Configuration of Radio Unit RU

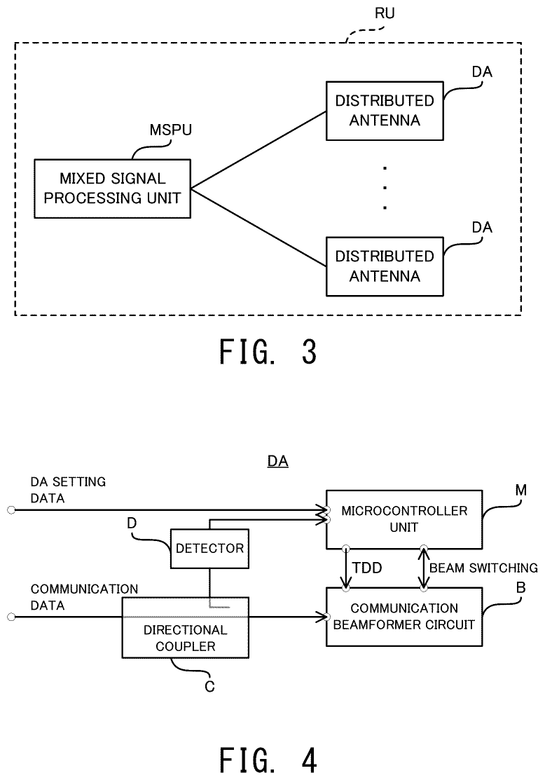

As illustrated in FIG. 3, a configuration of a radio unit RU is divided into a distributed antenna DA serving as the base-station secondary device and a mixed signal processing unit MSPU serving as the base-station primary device. The distributed antenna DA is mainly equipped with an analog front-end to an antenna. The mixed signal processing unit MSPU is equipped with a digital signal processor such as a modulator/demodulator. As illustrated in FIG. 3, communication signals of a plurality of distributed antennas DA are processed by a single mixed signal processing unit MSPU. Note that the unidirectional arrows in FIG. 4 indicate an example of the direction of flow of a signal (data) and do not exclude the bidirectional flow of a signal (data).

### 2-2: Configuration of Distributed Antenna DA

FIG. 4 is a block diagram illustrating a configuration of the distributed antenna DA according to the present disclosure. As illustrated in FIG. 4, the distributed antenna DA includes a micro controller unit (MCU) M, a detector D, a communication beamformer circuit B, and a directional coupler C.

The micro controller unit M is connected to a signal line for receiving control data transmitted from the mixed signal processing unit MSPU. The control data include DA setting data. The DA setting data include switching schedule data.

Communication data transmitted from the mixed signal processing unit MSPU may be an analogue signal such as a RF (Radio Frequency) signal, and an IF (Intermediate Frequency) signal. The directional coupler C extracts electric power of the communication data transmitted from the mixed signal processing unit MSPU.

The detector D detects a signal. The detector D may detect magnitude of the signal. The detector D may be an electric power detector. The detector D may be a power detector. The detector D may detect amplitude of the signal. The following describes a case of detecting the electric power by using the power detector, but it is merely an example. The detector D detects a rise and a fall of the electric power of the communication data transmitted from the mixed signal processing unit MSPU to the distributed antenna DA.

The communication beamformer circuit B includes an antenna for performing communication. The micro controller unit M includes a counter. The micro controller unit M controls the communication beamformer circuit B by using the counter.

### 2-3: Operation of Distributed Antenna DA

### a. Switching between Transmission and Reception

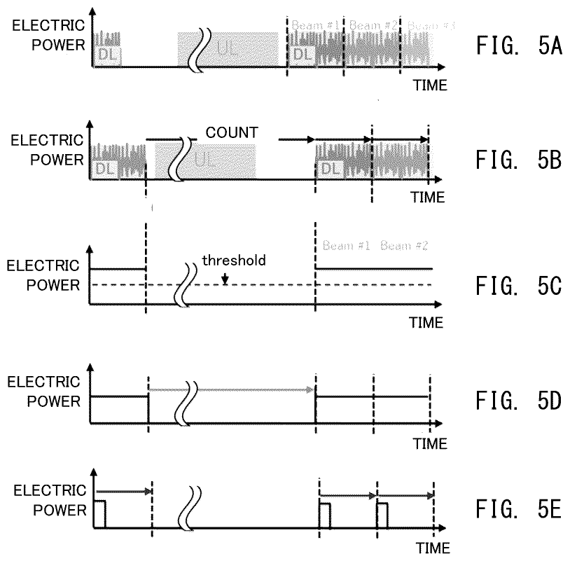

Now, let us consider a case where a mode of the mixed signal processing unit MSPU is switched from a transmission mode to a reception mode. FIG. 5A illustrates the communication data outputted by the radio unit RU. As illustrated in FIG. 5A, the mixed signal processing unit MSPU continues transmitting the communication data to the distributed antenna DA in the transmission mode, but does not transmit the communication data to the distributed antenna DA in the reception mode. FIG. 5B illustrates the communication data received by the distributed antenna DA. As illustrated in FIG. 5B, the communication data reach the distributed antenna DA after a certain delay.

The directional coupler C extracts the electric power of the communication data and inputs it to the detector D. The detector D outputs high or low electric power to the micro controller unit M, depending on whether or not the electric power extracted by the directional coupler C exceeds a certain threshold.

FIG. 5C illustrates an output of the detector D. As illustrated in FIG. 5C, the output of the detector D is high in response to the communication data being transmitted from the mixed signal processing unit MSPU, and is low in response to the communication data being not transmitted. Between an end time point of an arbitrary high state and a start time point of a next high state is the same as a time length in which the mixed signal processing unit MSPU operates in the reception mode. Therefore, the micro controller unit M may perform accurate synchronization even without control from the outside, by switching a TDD control signal based on a time point at which the output of the detector D is switched between high and low. FIG. 5D illustrates a time variation of a TDD switching signal.

### b. Beam Switching

Beam switching requires control during a transmitting operation. Therefore, the electric power of the communication data cannot be detected and set as a reference. The beam switching is performed by receiving the switching schedule data from the mixed signal processing unit MSPU in advance. The switching schedule data are included in the first information. The micro controller unit M stores a control time for each beam.

The micro controller unit M performs the beam switching as scheduled, by using the counter, from timing in which the output of the detector D becomes high. FIG. 5E illustrates the beam switching. As illustrated in FIG. 5E, the micro controller unit M measures a time length from a time point at which the output of the detector D becomes high, and sequentially performs the beam switching as scheduled. Thus, the micro controller unit M allows time synchronization of beam control, without receiving a high-precision synchronization signal from the mixed signal processing unit MSPU.

The beam switching schedule data only need to be received in advance, and accurate time synchronization is not required. For this reason, the mixed signal processing unit MSPU does not require delay-offset control or the like.

### 2-4: Technical Effect of Distributed Antenna DA Serving as Base-Station Secondary Device

In some cases, the time synchronization is realized by transmitting data for setting of the distributed antenna DA, a beam switching signal for performing the beam control of the distributed antenna DA, the TDD control signal for performing switching control of communication transmission and reception, and the communication data from the mixed signal processing unit MSPU to the distributed antenna DA. In this case, a plurality of lines for respectively transmitting the signals are provided between the mixed signal processing unit MSPU and the distributed antenna DA. Alternatively, a plurality of signals are multiplexed on a single signal line for transmission.

Delays occur while these signals are propagated over a long distance between the mixed signal processing unit MSPU and the distributed antenna DA. The length of the delay varies due to differences in signal line characteristics and frequency. The difference in the length of the delay causes a timing difference between the communication data and each of the TDD control signal and the beam switching signal, thereby disabling highly accurate time synchronization. A DA setting signal does not need to be time-synchronized with the communication data.

The problem that the TDD control signal and the beam switching signal are not synchronized with the communication data, may be solved by measuring in advance a difference in propagation delay of each signal between the mixed signal processing unit MSPU and the distributed antenna DA and by an arithmetic apparatus of the mixed signal processing unit MSPU transmitting each signal with an offset applied to transmission timing of the signal. The difference in delay of each signal, however, is not unique since it depends on a distance between the mixed signal processing unit MSPU and the distributed antenna DA. For this reason, when a plurality of distributed antennas DA are installed, the signals are to be measured individually for each distributed antenna DA. This is costly and complicates signal processing of the mixed signal processing unit MSPU.

In contrast, the distributed antenna DA according to the present disclosure detects the electric power of the communication data to be transmitted to the distributed antenna DA from the mixed signal processing unit MSPU, and performs TDD time control and the beam switching, based on time points of the rise and the fall of the electric power. The operation of the distributed antenna DA allows highly accurate time synchronization without complicated error correction control or the like. Even at the long distance between the mixed signal processing unit MSPU and the distributed antenna DA, the time synchronization of the signals may be realized.

### 3: Third Example Embodiment

A base-station device included in a base-station radio unit, an information processing method, a computer program, and a recording medium according to a third example embodiment will be described. The following describes the base-station device included in the base-station radio unit, the information processing method, the computer program, and the recording medium according to the third example embodiment, by using the distributed antenna DA serving as the base-station secondary device according to the present disclosure.

### 3-1: Configuration of Distributed Antenna DA

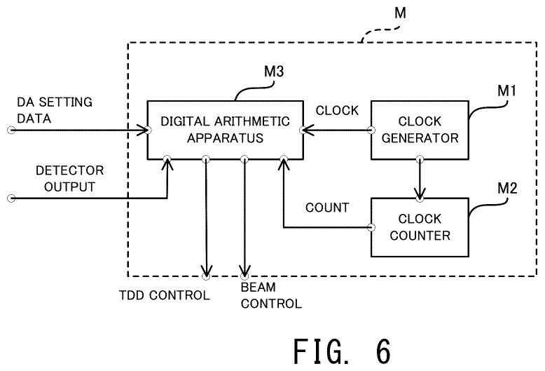

FIG. 6 illustrates a configuration of the micro controller unit M. As illustrated in FIG. 6, the micro controller unit M internally includes a clock generator M1, a clock counter M2, and a digital arithmetic apparatus M3. The clock generator M1 generates a clock. The clock counter M2 receives and counts the clock. The digital arithmetic apparatus M3 receives the DA setting data transmitted from the mixed signal processing unit MSPU, a detection result of the electric power of the communication data outputted from the detector D, and an output from the clock counter M2. The digital arithmetic apparatus M3 generates the TDD control signal and a beam control signal, based on the received information. The digital arithmetic apparatus M3 outputs the TDD control signal and the beam control signal to the communication beamformer circuit B. Note that the unidirectional arrows in FIG. 6 indicate an example of the direction of flow of a signal (data) and do not exclude the bidirectional flow of a signal (data).

### 3-2: Premise of Operation of Distributed Antenna DA

The distributed antenna DA transmits n_s slots, each having a time slot length t_s, during the transmitting operation. A beam ID when an n-th slot is transmitted, is ID_n.

The micro controller unit M receives slot information and a schedule of beam switching transmitted by the mixed signal processing unit MSPU, from a line that receives the DA setting data. The beam switching schedule data are a set of respective beam IDs of the n_s slots. That is, the beam switching schedule data are a sequence of n_s integers that are ID_1, ID_2, . . . , and ID_n_s.

To which type of beam each ID_n corresponds, is stored in an internal memory of the digital arithmetic apparatus M3, as known information. A clock frequency of the clock generated by the clock generator M1 is f_c. A cycle prefix of each symbol is t_c.

### 3-3: Operation of Distributed Antenna DA

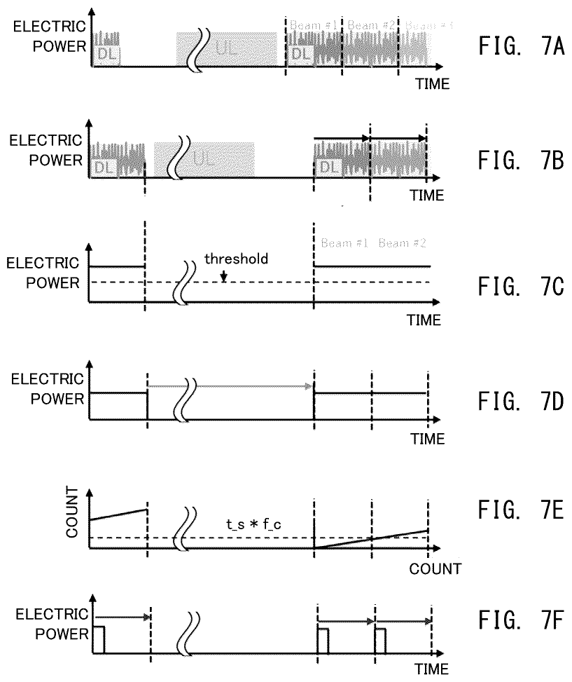

With reference to FIG. 7A to FIG. 7F, a flow of synchronous control of the distributed antenna DA will be described. FIG. 7A illustrates the communication data output by the radio unit RU. FIG. 7B illustrates the communication data received by the distributed antenna DA. FIG. 7C illustrates the output of the detector D. FIG. 7D illustrates TDD switching by the digital arithmetic apparatus M3. FIG. 7E illustrates the clock counting by the clock counter M2. FIG. 7F illustrates the beam switching by the digital arithmetic apparatus M3.

For convenience, a starting point in the description of the operation may be immediately before an end of the transmitting operation of the distributed antenna DA. During the transmitting operation of the distributed antenna DA, the output of the detector D is high, since the communication data are transmitted from the mixed signal processing unit MSPU to the distributed antenna DA. The digital arithmetic apparatus M3 to which the high output is inputted, performs TDD control in the transmission mode.

When the mode of the mixed signal processing unit MSPU is switched to the reception mode and stops transmitting the communication data to the distributed antenna DA, the electric power of the communication data becomes zero at an input end of the distributed antenna DA, after the delay of a line between the mixed signal processing unit MSPU and the distributed antenna DA. Thus, the output of the detector D is switched to low. The digital arithmetic apparatus M3 switches the TDD control into the reception mode, in response to this low output. During this reception mode operation, the beam switching schedule data (t_s, n_s, ID_n) are transmitted from the mixed signal processing unit MSPU to the digital arithmetic apparatus M3 of the distributed antenna DA, and are stored in the internal memory of the digital arithmetic apparatus M3.

After the reception mode operation, the mode of the mixed signal processing unit MSPU is switched to the transmission mode, and the mixed signal processing unit MSPU transmits the communication data to the distributed antenna DA. When the communication data reach the distributed antenna DA, an inverse operation of the series of operations is performed, and the digital arithmetic apparatus M3 switches the TDD control into the transmission mode. In addition, the digital arithmetic apparatus M3 switches the beam ID of the communication beamformer circuit B to ID_1, at the same time as switching the TDD control.

At this time, a time length from a time point at which the communication data reach the distributed antenna DA to an end of the switching between the beam control and the TDD control, may be set at most within a cycle prefix t_c of the symbol. In a case where subcarrier spacing is 240 kHz, then, the cycle prefix t_c is 0.3 μs, and it is desirable that the series of operations ends within 0.15 μs. In a case where a system clock of the micro controller unit M is 72 MHz, a clock period is about 14 ns. Therefore, it is possible to satisfy an operation time condition.

After the switching between the TDD control and the beam control, the clock counter M2 starts to count the clock. The digital arithmetic apparatus M3 calculates t_s*f_c and rounds it off, thereby obtaining the number of clocks generated before the switching between the slots. After the clock counter M2 counts the number of clocks obtained on the basis of t_s*f_c, the digital arithmetic apparatus M3 switches the beam ID to ID_2. The digital arithmetic apparatus M3 then determines an integer obtained by rounding off 2*t_s*f_c, based on a time point at which the TDD control is switched. The digital arithmetic apparatus M3 switches the beam ID to ID_3 in timing in which this integer number of clocks are counted.

The digital arithmetic apparatus M3 repeats this operation until the clock is counted by a number of times obtained by rounding off (n_s−1)*t_s*f_c.

By determining a beam switching time point based on a TDD switching time point, it is possible to avoid accumulation of errors caused in the calculation of t_s*f_c. Here, an error between t s and a value that is obtained by multiplying, by (1/f_c), an integer obtained by rounding off t_s*f_c, must be set at most within the cycle prefix t_c.

After a lapse of n_s*t_s from the switching of the TDD control into the transmission mode, there are no longer any communication data transmitted from the mixed signal processing unit MSPU, and the output of the detector D is switched to low. The digital arithmetic apparatus M3 switches the TDD control into the reception mode in response to this low output, and returns into its original state.

### 4: Fourth Example Embodiment

A base-station device included in a base-station radio unit, an information processing method, a computer program, and a recording medium according to a fourth example embodiment will be described. The following describes the base-station device included in the base-station radio unit, the information processing method, the computer program, and the recording medium according to the fourth example embodiment, by using the distributed antenna DA serving as the base-station secondary device according to the present disclosure.

### 4-1: Delay Time t_d

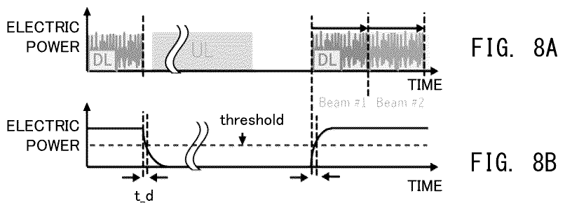

FIG. 8A and FIG. 8B illustrate a delay t_d required for inversion of the output of the detector D, from the change in the electric power at the communication data input end of the distributed antenna DA. FIG. 8A illustrates the communication data received by the distributed antenna DA, and FIG. 8B illustrates the output of the detector D. FIG. 8A and FIG. 8B illustrate a case where there is a time difference in the output of the detector D and the signal switching.

The fourth example embodiment describes an operation performed in a case where the delay time t_d is greater than the cycle prefix t_c and cannot be ignored. The fourth example embodiment takes into account a time required for the communication data transmitted from the mixed signal processing unit MSPU to reach the distributed antenna DA, and describes a case where there is a standby time, which is longer than the delay time t_d, when the transmitting operation is switched to a receiving operation.

### 4-2: Operation of Distributed Antenna DA

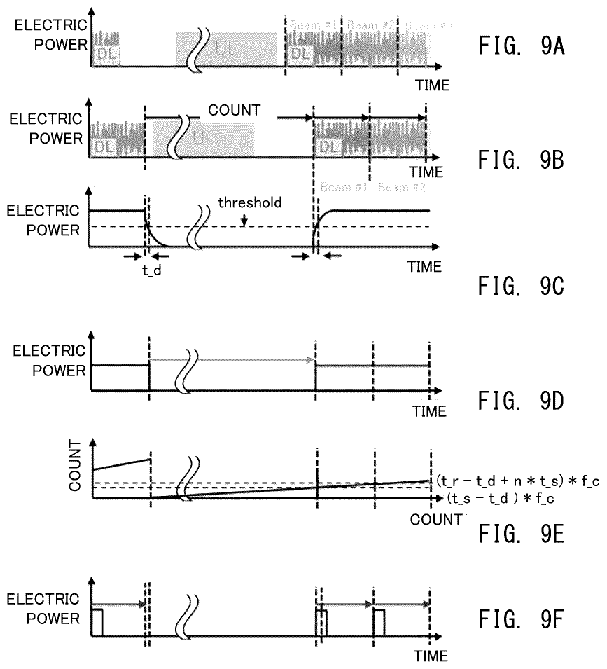

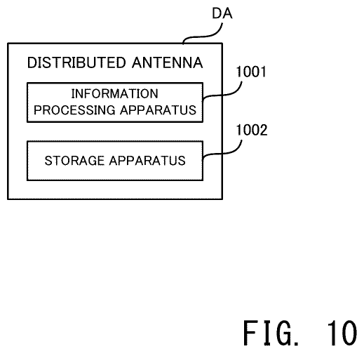

With reference to FIG. 9A to FIG. 9F, a flow of the synchronous control of the distributed antenna DA will be described. FIG. 9A illustrates the communication data outputted by the radio unit RU. FIG. 9B illustrates the communication data received by the distributed antenna DA. FIG. 9C illustrates the output of the detector D. FIG. 9D illustrates the TDD switching by the digital arithmetic apparatus M3. FIG. 9E illustrates the clock counting by the clock counter M2. FIG. 9F illustrates the beam switching by the digital arithmetic apparatus M3.

For convenience, a starting point in the description of the operation may be immediately before an end of the transmitting operation of the distributed antenna DA. As illustrated in FIG. 9A to FIG. 9F, when the operation of the mixed signal processing unit MSPU is switched from the transmitting operation to the receiving operation, the detector D is inverted due to no electric power of the communication data. The operation of the distributed antenna DA is switched to the receiving operation, and the digital arithmetic apparatus M3 of the distributed antenna DA starts to count the clock. Now, a time from when the mixed signal processing unit MSPU completes the transmitting operation to when it starts a next transmitting operation, is set as a reception time t_r. When the count of clocks reaches a number of times obtained by rounding of (t_r−t_d)*f_c, the digital arithmetic apparatus M3 switches the operation of the distributed antenna DA from the receiving operation to the transmitting operation. That is, the digital arithmetic apparatus M3 switches the operation of the distributed antenna DA from the receiving operation to the transmitting operation, based on the reception time t_r corrected by the delay time t_d. The reception time t_r is received from the mixed signal processing unit MSPU in any timing during the transmitting operation. The delay time t_d is known by measurement at the time of manufacturing the distributed antenna DA.

After the operation of the distributed antenna DA is switched to the transmitting operation, the digital arithmetic apparatus M3 performs the beam switching at each time when the count of clocks becomes s number of times obtained by rounding off f_c*(t_r−t_d+n*t_s) (n=1, 2, . . . , and n_s−1). After the transmitting operation is completed, it is switched to the receiving operation, based on the output of the detector D as described above.

### 5: Fifth Example Embodiment

A base-station device included in a base-station radio unit, an information processing method, a computer program, and a recording medium according to a fifth example embodiment will be described. The following describes the base-station device included in the base-station radio unit, the information processing method, the computer program, and the recording medium according to the fifth example embodiment, by using the distributed antenna DA serving as the base-station secondary device according to the present disclosure.

As illustrated in FIG. 10, the distributed antenna DA according to the present disclosure may include an information processing apparatus 1001 and a storage apparatus 1002.

The information processing apparatus 1001 may include at least one of a CPU (Central Processing Unit), a GPU (Graphic Processing Unit), and a FPGA (Field Programmable Gate Array). The information processing apparatus 1001 may read a computer program. For example, the information processing apparatus 1001 may read a computer program stored in the storage apparatus 1002. For example, the information processing apparatus 1001 may read a computer program stored in a computer-readable recording medium, by using a not-illustrated recording medium reading apparatus. The information processing apparatus 1001 may acquire (i.e., download or read) a computer program from a not-illustrated apparatus disposed outside the distributed antenna DA via a not-illustrated communication apparatus. The information processing apparatus 1001 executes the read computer program. As a consequence of the execution of the computer program, a logical functional block for performing an operation to be performed by the distributed antenna DA is realized or implemented in the information processing apparatus 1001. Specifically, a logical functional block for performing the information processing operation is realized or implemented in the information processing apparatus 1001. That is, the information processing apparatus 1001 is allowed to function as a controller for realizing or implementing the logical functional block for performing an operation to be performed by the distributed antenna DA.

The storage apparatus 1002 is configured to store desired data. For example, the storage apparatus 1002 may temporarily store a computer program to be executed by the information processing apparatus 1001. The storage apparatus 1002 may temporarily store data that are temporarily used by the information processing apparatus 1001 when the information processing apparatus 1001 executes the computer program. The storage apparatus 1002 may store data that are stored by the distributed antenna DA for a long time. The storage apparatus 1002 may include at least one of a RAM (Random Access Memory), a ROM (Read Only Memory), a hard disk apparatus, a magneto-optical disk apparatus, a SSD (Solid State Drive), and a disk array apparatus.

### 6: Supplementary Notes

With respect to the example embodiments described above, the following Supplementary Notes are further disclosed.

### Supplementary Note 1

A base-station device included in a base-station radio unit, the base-station device is a base-station secondary device, the base-station secondary device including:
a first information acquisition part that acquires first information indicating a schedule of signal switching outputted by a base-station primary device included in the base-station radio unit;
a second information acquisition part that acquires second information indicating at least one of a rise and a fall of an output signal outputted by the base-station primary device;
a counter; and
a switching part that performs the signal switching by using the counter, based on the first information and the second information.

### Supplementary Note 2

The base-station device according to Supplementary Note 1, wherein
the second information acquisition part acquires the second information indicating the rise of the output signal, and
the switching part performs the signal switching by using the counter, based on the rise of the output signal.

### Supplementary Note 3

The base-station device according to Supplementary Note 2, wherein
the first information includes information indicating a time slot length, and
the switching part performs beam switching by using the counter, based on the time slot length and a period of the counter.

### Supplementary Note 4

The base-station device according to Supplementary Note 3, wherein
the first information includes a time slot length, and
the switching part counts, by using the counter, an integer obtained by rounding off a result of division of an integer multiple of the time slot length by the period of the counter, and performs the beam switching.

### Supplementary Note 5

The base-station device according to Supplementary Note 1, wherein
the second information acquisition part acquires the second information indicating the fall of the output signal, and
the switching part performs the signal switching, based on the fall of the output signal.

### Supplementary Note 6

The base-station device according to Supplementary Note 5, wherein
the first information includes information indicating a reception time from when a state of the base-station radio unit is switched from a transmission state to a reception state, to when it is switched from the reception state to a next transmission state, and
the switching part switches between transmission and reception by using the counter, based on a delay time regarding detection of at least one of the rise and the fall of the output signal outputted by the base-station primary device, the reception time, and a period of the counter.

### Supplementary Note 7

The base-station device according to Supplementary Note 6, wherein the switching part counts, by using the counter, an integer obtained by rounding off a result of division, by the period of the counter, of a difference between the reception time and the delay time regarding detection of at least one of the rise and the fall of the output signal outputted by the base-station primary device, and switches between the transmission and the reception.

### Supplementary Note 8

The base-station device according to Supplementary Note 7, wherein
the first information includes a time slot length, and
the switching part counts, by using the counter, an integer obtained by rounding off a result of division, by the period of the counter, of a time obtained by adding an integer multiple of the time slot length to the difference, and performs beam switching.

### Supplementary Note 9

An information processing method used by a base-station secondary device included in a base-station radio unit, the information processing method including:
acquiring first information indicating a schedule of signal switching outputted by a base-station primary device included in the base-station radio unit;
acquiring second information indicating at least one of a rise and a fall of an output signal outputted by the base-station primary device; and
performing the signal switching by using a counter included in the base-station secondary device, based on the first information and the second information.

### Supplementary Note 10

A non-transitory recording medium on which a computer program that allows a computer to execute an information processing method is recorded, the information processing method including:
acquiring first information indicating a schedule of signal switching outputted by a base-station primary device included in a base-station radio unit;
acquiring second information indicating at least one of a rise and a fall of an output signal outputted by the base-station primary device; and
performing the signal switching by using a counter included in a base-station secondary device in the base-station radio unit, based on the first information and the second information.

### Supplementary Note 11

A computer program that allows a computer to execute an information processing method, the information processing method including:
acquiring first information indicating a schedule of signal switching outputted by a base-station primary device included in a base-station radio unit;
acquiring second information indicating at least one of a rise and a fall of an output signal outputted by the base-station primary device; and
performing the signal switching by using a counter included in a base-station secondary device included in the base-station radio unit, based on the first information and the second information.

The present disclosure is not limited to the above-described examples and is allowed to be changed, if desired, without departing from the essence or spirit of the invention which can be read from the claims and the entire specification. A base-station device, an information processing method, and a non-transitory recording medium with such changes, are also included in the technical concepts of the present disclosure.

### DESCRIPTION OF REFERENCE NUMERALS

100 Base-station secondary device
111 First information acquisition part
112 Second information acquisition part
113 Counter
114 Switching part
RU Radio unit
DA Distributed antenna
MSPU Mixed signal processing unit
M Micro controller unit
D Detector
B Communication beamformer circuit
C Directional coupler
M1 Clock generator
M2 Clock counter
M3 Digital arithmetic apparatus

What is claimed is:

1. A base-station device included in a base-station radio unit, the base-station device is a base-station secondary device, the base-station secondary device comprising:
at least one memory that is configured to store instructions; and
at least one processor that is configured to execute the instructions to:
acquire first information indicating a schedule of signal switching outputted by a base-station primary device included in the base-station radio unit;
acquire second information indicating at least one of a rise and a fall of an output signal outputted by the base-station primary device; and
perform the signal switching by using a counter included in the base-station secondary device, based on the first information and the second information.

2. The base-station device according to claim 1, wherein the at least one processor is configured to execute the instructions to:
acquire the second information indicating the rise of the output signal; and
perform the signal switching by using the counter, based on the rise of the output signal.

3. The base-station device according to claim 2, wherein
the first information includes information indicating a time slot length, and
the at least one processor is configured to execute the instructions to perform beam switching by using the counter, based on the time slot length and a period of the counter.

4. The base-station device according to claim 3, wherein
the first information includes a time slot length, and
the at least one processor is configured to execute the instructions to: count, by using the counter, an integer obtained by rounding off a result of division of an integer multiple of the time slot length by the period of the counter; and perform the beam switching.

5. The base-station device according to claim 1, wherein the at least one processor is configured to execute the instructions to:
acquire the second information indicating the fall of the output signal; and
perform the signal switching, based on the fall of the output signal.

6. The base-station device according to claim 5, wherein
the first information includes information indicating a reception time from when a state of the base-station radio unit is switched from a transmission state to a reception state, to when it is switched from the reception state to a next transmission state, and
the at least one processor is configured to execute the instructions to switch between transmission and reception by using the counter, based on a delay time regarding detection of at least one of the rise and the fall of the output signal outputted by the base-station primary device, the reception time, and a period of the counter.

7. The base-station device according to claim 6, wherein the at least one processor is configured to execute the instructions to: count, by using the counter, an integer obtained by rounding off a result of division, by the period of the counter, of a difference between the reception time and the delay time regarding detection of at least one of the rise and the fall of the output signal outputted by the base-station primary device and switch between the transmission and the reception.

8. The base-station device according to claim 7, wherein
the first information includes a time slot length, and
the at least one processor is configured to execute the instructions to: count, by using the counter, an integer obtained by rounding off a result of division, by the period of the counter, of a time obtained by adding an integer multiple of the time slot length to the difference; and perform beam switching.

9. An information processing method used by a base-station secondary device included in a base-station radio unit, the information processing method comprising:
acquiring first information indicating a schedule of signal switching outputted by a base-station primary device included in the base-station radio unit;
acquiring second information indicating at least one of a rise and a fall of an output signal outputted by the base-station primary device; and
performing the signal switching by using a counter included in the base-station secondary device, based on the first information and the second information.

10. A non-transitory recording medium on which a computer program that allows a computer to execute an information processing method is recorded, the information processing method including:
acquiring first information indicating a schedule of signal switching outputted by a base-station primary device included in a base-station radio unit;
acquiring second information indicating at least one of a rise and a fall of an output signal outputted by the base-station primary device; and
performing the signal switching by using a counter included in a base-station secondary device included in the base-station radio unit, based on the first information and the second information.
